(19) United States
(12) Patent Application Publication
(10) Pub. No.: US 2024/0139821 A1
(43) Pub. Date: May 2, 2024

(54) DEPOWDERING OF 3D-PRINTED STRUCTURES

(71) Applicant: Divergent Technologies, Inc., Los Angeles, CA (US)

(72) Inventors: Michael Thomas KENWORTHY, Rancho Palos Verdes, CA (US); Bahram ISSARI, Laguna Niguel, CA (US); Taylor Caitlin DOTY, Redondo Beach, CA (US); Konstantin WIPLINGER, Rancho Palos Verdes, CA (US)

(21) Appl. No.: 18/499,072

(22) Filed: Oct. 31, 2023

Related U.S. Application Data
(60) Provisional application No. 63/421,454, filed on Nov. 1, 2022.

(51) Int. Cl. B22F 12/70; B22F 12/00; B22F 12/90; B33Y 30/00

(52) U.S. Cl. CPC B22F 12/70; B22F 12/226; B22F 12/38; B22F 12/90; B33Y 30/00; B22F 2202/01

(57) ABSTRACT

The present aspects include a system for de-powdering a three-dimensionally (3D) printed structure. The structure comprising a first component holder configured to removably hold the 3D printed structure at an initial orientation with respect to at least one opening to a hollow portion within the 3D printed structure; a fluid system configured control a fluid to at least apply the fluid to the hollow portion or remove the fluid from the hollow portion to remove a powder from the hollow portion; and a movement system configured to move at least the 3D printed structure or the fluid system according to a movement procedure based on a configuration of the hollow portion.

### CROSS-REFERENCE TO RELATED APPLICATIONS

This application claims priority to U.S. Provisional Application No. 63/421,454 titled “DEPOWDERING OF 3D-PRINTED STRUCTURES” filed Nov. 1, 2022, which is assigned to the assignee hereof, and incorporated by reference in its entirety as if fully set forth herein.

### TECHNICAL FIELD

The present disclosure generally relates to the depowdering of complex additively manufactured (AM) structures and components, and more specifically to maximizing material recovery for efficient scaled AM operations.

### BACKGROUND

Depowdering of complex printed AM components is a critical post-processing task. The reactive metal powder is an inherently hazardous material that can also interfere with subsequent processes like coating and is also a significant economic consideration with raw materials generally in the 10s to 100s of USD/kg for powder bed fusion processes. Therefore, maximizing material recovery is a priority for efficient scaled AM operations, and poses a need for an efficient method of material recovery for AM operations.

Fine metal powder readily picks up moisture from the air and once above a few percent relative humidity the powder begins to stick or cling to surfaces. Vibration may help, both high and low frequency, to initiate flow of trapped material. The use of compressed gas may be another technique to move the material. For some applications and manufacturing processes, active flow of a liquid is used to clean internal passages of flow bodies, such as valves, heat exchangers, 3d printed organs, etc.

Further, complex parts typically do not have a direct line of sight to areas where powders may be trapped. The designs may also have multiple areas for material egress for various reasons, possibly of complex shapes themselves which may be difficult to seal, and which ultimately limits the general applicability and usefulness of suction-based removal. This material recovery challenge is exacerbated by the limitations of de-powdering multiple components on the build plate simultaneously. While convenient for work holding purposes, the internal geometries of the several components have different egress points and optimal orientations. Specialized software to recognize the internal features and suggest a cycle to efficiently remove the material from a convoluted passage may be used; considering even a simple shape like a canonical U-bend geometry where the material will just flow back and forth but not fully exit the tube even over several cycles. For more complex topologically optimized internal structures, guarantee of a necessary cleanliness target can be an order of magnitude more difficult to repeatably accomplish. It may be impossible to accomplish in an economically reasonable way for some designs in certain industrial segments.

Therefore an efficient depowdering mechanism that can bear all of the above features and challenges is needed.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to one example, a system for de-powdering a three-dimensionally (3D) printed structure, comprises: a component holder configured to removably hold the 3D printed structure at an initial orientation with respect to at least one opening to a hollow portion within the 3D printed structure; a fluid system configured control a fluid to at least apply the fluid to the hollow portion or remove the fluid from the hollow portion to remove a powder from the hollow portion; and a movement system configured to move at least the 3D printed structure or the fluid system according to a movement procedure based on a configuration of the hollow portion

Another example aspect includes, a system for de-powdering wherein the fluid system includes an internal fluid channel within a portion of the component holder, wherein the internal fluid channel is in fluid connection with a first opening to the hollow portion when the 3D printed structure is affixed to the component holder, such that the fluid flows through the portion of the component holder and the first opening to at least apply the fluid to the hollow portion or remove the fluid from the hollow portion.

Another example aspect includes, a system for de-powdering further comprising a second component holder configured to removably hold a second 3D printed structure at a second initial orientation with respect to at least one opening to a hollow portion within the second 3D printed structure, wherein the fluid system is further configured to at least apply the fluid to the hollow portion of the second 3D printed structure or remove the fluid from the hollow portion of the second 3D printed structure, and the movement system is further configured to move at least the second 3D printed structure or the fluid system according to a movement procedure based on a configuration of the hollow portion of the second 3D printed structure.

Another example aspect includes a system for de-powdering wherein the fluid system includes a first internal fluid channel within a portion of the first component holder and a second internal fluid channel within a portion of the second component holder, wherein the first internal fluid channel and the second internal fluid channel are connected to one another.

Another example aspect includes a system for de-powdering further comprising a rigid structure connecting the component holder and the second component holder, wherein the movement system is configured to move the rigid structure such that the component holder and the second component holder are moved at the same time.

Another example aspect includes a system for de-powdering wherein the movement procedure of the movement system includes a vibration and a rotation configured to be applied to the 3D printed structure in a combination based on the configuration of the hollow portion.

Another example aspect includes a system for de-powdering further comprising a sensor system configured sense an amount of at least the powder or the fluid that is located within the hollow portion and adjust at least the control of the fluid by the fluid system of the movement of the movement system based on the sensed amount.

Another example aspect includes a system for depowdering wherein the component holder is configured to be affixed to a 3-D printing build plate.

Another example aspect includes a system for depowdering further comprising an external fluid source including a nozzle or plurality of nozzles configured to at least a apply a fluid to the hollow portion of the 3D printed structure at a second opening to the hollow portion within the 3D printed structure.

Another example aspect includes a system for depowdering wherein the external fluid source is movable around the 3D printed structure to apply the fluid to the hollow portion of the 3D printed structure at a plurality of different openings to the hollow portion within the 3D printed structure.

Another example aspect includes a system for depowdering wherein the plurality of nozzles may be configured to apply a fluid to the hollow portion of a plurality of different 3D printed structures located on a plurality of different component holders.

Another example aspect includes a system for depowdering further comprising an external housing member configured to house and enclose at least the first component holder, the 3D printed structure, the fluid system and the movement system.

Another example aspect includes a system for depowdering wherein the external housing member may further include a pump or exhaust member and a powder collection member.

Another example aspect includes a system for depowdering wherein the external housing member may include a rigid chamber, or more flexible system such as a bubble, and wherein the external housing member is variable in size and volume.

Another example aspect includes a system for depowdering wherein the external housing member may provide an inert environment below the reactivity limit of the utilized material of the 3D printed structure.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a front view of an exemplary depowdering system.

FIG. 2 is a side view of an exemplary robotic arm depowdering system.

### DETAILED DESCRIPTION

Various aspects of the disclosure are now described with reference to the drawings, wherein like reference numerals are used to refer to elements throughout. In the following description, for purposes of explanation, numerous specific details are set forth in order to promote a thorough understanding of one or more aspects of the disclosure. It may be evident in some or all instances, however, that any aspects described below can be practiced without adopting the specific design details described below.

Aspects of the disclosure include system for de-powdering a three-dimensionally (3D) printed structure including a component holder, a fluid system, a movement system and an environmental system.

In one example implementation, which should not be construed as limiting, the de-powdering system may include a component holder configured to hold the 3D-printed structure or part, a fluid system configured to introduce a fluid or gas into the 3D-printed structure or part in order to remove a powder from the part, a movement system configured to move the 3D-printed structure or part at least in order to aid the movement of the fluid or gas through the 3D-printed structure or to further remove the powder from the 3D-printed structure or part, and an environmental system to provide and inert environment for the depowdering process.

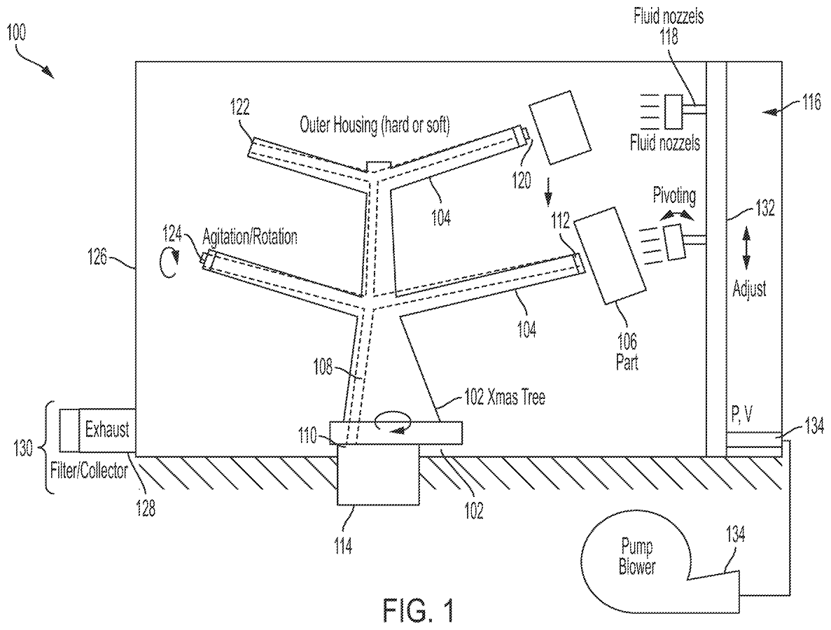

Referring specifically to FIG. 1, in one example implementation that should not be construed as limiting, the de-powdering system 100 includes a base member 102, wherein the base member 102 is configured to include at least one component holder 104. The at least one component holder 104, is configured to hold a 3-D printed component or part 106 during the depowdering of the 3-D printed component or part 106 after the part 106 has been 3-D printed or after a portion of the part 106 has been 3-D printed during an additive manufacturing process. The component holder 104 is configured to hold the part 106 at an initial orientation, wherein the initial orientation is determined with respect to an opening, or plurality of openings located within the part 106 to a hollow internal structure of the part 106. The part 106 may be held by the component holder 104 through the use of a robotic-gripping feature, clamping feature, or other holding mechanism that may be modified to provide a channel for high pressure gas or fluid, hereafter referred to as “fluid”, to be delivered to the internal passages of the component 106. This ideally forms a topologically closed surface aka “manifold”, rather than multiple disjointed volumes.

The de-powdering system 100 may further include a fluid system. In one example implementation the fluid system may comprise an internal fluid channel 108 within a portion of the component holder 104 and the base member 102. The internal fluid channel 108 may extend from a first fluid channel end 110 which is located in the base member 102 to a second fluid channel end 112, which is located at a distal end of the component holder 104. In the described example implementation the component holder 104 may hold the part 106 at an initial orientation, such that the second fluid channel end 112 is in fluid connection with an opening located within the part 106 leading to a hollow internal structure of the part 106. This in turn puts the fluid channel 108 in fluid communication with the hollow internal structure of the part 106. The initial orientation is further determined by taking into account the internal part geometry and potential or ideal egress paths and distances for logical sub-volumes of the internal part geometry.

In the described example implementation a fluid may enter the internal fluid channel 108 and in turn the base member 102 from a fluid source 114, which is connectable to the first fluid channel end 110. The fluid may then move through the internal fluid channel 108, which runs through the component holder 104, where it may then exit the internal fluid channel 108 at the second fluid channel end 112, which is oriented in line with an opening of the part 106, which leads to a hollow internal structure of the part 106. The fluid may then be pushed throughout the internal structure of the part 106, and will thereby remove or expel loose or excess powder located within the internal structure of the part 106. The “fluid”, which may be utilized, in the depowdering process may include, but is not limited to a liquid such as water, alcohol, etc. or a compressed gas such as air, nitrogen gas, carbon dioxide, noble gases, etc. or combinations thereof.

Additionally, the internal channel 108 may be utilized to incorporate suction to the part 106. Therefore, instead of injecting fluid into the part 106, or after injecting fluid into the part, suction may be utilized to remove powder from the internal structure of the part 106. Further, excess powder may be sucked into the internal channel 108, through second fluid channel end 112 and may then be expelled into an excess powder chamber through the first fluid channel end 110.

In addition to the use of an internal fluid channel 108, the depowdering system 100, may alternatively or additionally utilize an external fluid source 116. The external fluid source 116 may in an example aspect include an external nozzle 118 or a plurality of external nozzles 118. The external nozzle or nozzles 118 may be adjustable in height and additionally may be moveable around the various openings of the part 106 as the fluid is being introduced to the part 106. For example as fluid is introduced to the internal structure of the part 106 via the second fluid channel end 112 located within the component holder 104, fluid may additionally be introduced to the internal structure of the part 106 via the external nozzle or nozzles 118 at a different opening or different plurality of openings of the internal structure of the part 106. This allows for additional removal of excess powder from the internal structure of the part 106 to ensure the maximum removal of excess powder during the depowdering process. The fluid, which may be utilized by the nozzle or nozzles 118, in the powdering process may include, but is not limited to a liquid such as water, alcohol, etc. or a compressed gas such as air, nitrogen gas, carbon dioxide, noble gases, etc. or combinations thereof.

The external fluid source 116 may in an example aspect include an external nozzle 118, or may alternatively or additionally include a vacuum or other suction device. For example fluid may be introduced to the internal structure of the part 106 via the second fluid channel end 112 and the external nozzle or nozzles 118, and an additional vacuum may move around the part in unison with the external nozzle 118, which sucks in the fluid, including the excess powder, after it has moved through the internal structure of the part 106.

The external fluid source 116, may further include an external fluid source chamber or channel 132 that is connectable to each nozzle or plurality of nozzles 118 and an external fluid source pump 134. The pump 134, may further include a suction feature so as to allow the nozzles 118 to both push fluid through the internal structure of the part 106 and provide a suction feature to remove excess fluids and powder from the internal structure of the part 106.

In a further example implementation, the de-powdering system 100 may further include a second component holder 104, or a plurality of additional component holders 104. Each component holder may utilize the same depowdering methods as described above. For example a plurality of internal fluid channels 108 may extend from a first fluid channel end 110, which is located in the base member 102 to a second fluid channel end 112 located at the distal end of each individual component holder 104.

As can be seen in FIG. 1, the internal fluid channel 108 may extend from a first fluid channel end 110, which is located in the base member 102, and may branch off to a second fluid channel end 112 located at the distal end of one of the plurality of component holders 104, and may additionally branch off to a third fluid channel end 120 located at the distal end of a different one of the plurality of component holders 104, and similarly may branch off to a fourth and fifth fluid channel ends 122, 124 each located at the distal end of a different one of the plurality of component holders 104. This allows for a plurality of parts, which may be the same or different, to be de-powdered simultaneously, and to utilize the same internal fluid source. Additionally each of the plurality of component holders 104 may have a corresponding external fluid source 116, including and external nozzle or nozzles 118 and a vacuum.

The de-powdering system 100 may further include a movement system. The movement system is configured to move at least the 3D printed structure 106 or the fluid system described above according to a movement procedure based on a configuration of the hollow portion of the 3D printed structure 106. The movement system 100, may be configured to move the base member 102, which in turn may move the component holder 104, or the plurality of component holders 104. The movement of the base member may include, but is not limited to rotating the base member 102 or vibrating the base member 102, and in turn the plurality of component holders 104 and the part 106. Therefore the base member 102 may rotate or vibrate as the fluid system described above is introducing fluid to the part 106. For example as fluid is moving throughout the internal components of the part 106, the base member may be simultaneously rotating and vibrating to further move the fluid throughout the internal components of the part 106 and to shake loose any excess powder which may be stuck or otherwise lodged within the internal components of the part 106.

Similarly each individual component holder 104, of the plurality of component holders 104 is configured to be movable. In one example implementation, each individual component holder 104 of the plurality of component holders 104 may be movable similar to a robotic arm, or may be rotatable to change the orientation of the internal components of the part 106 and in turn further move the fluid throughout the internal components of the part 106 and to shake loose any excess powder within the part 106. For example as fluid is moving throughout the internal components of the part 106, and the base member 102 may be simultaneously rotating and vibrating, the each individual component holder 104 of the plurality of component holders 104 may concurrently be moving to change the orientation of the part 106. This combination of the fluid system described above with the movement system of the base member 102 and the movement system of the each individual component holder 104, of the plurality of component holders 104 allows for an efficient removal of powder from the internal components of the part 106.

The de-powdering system 100 may further include a sensor assembly or sensor system. The sensor system may be utilized for validating the success of the depowdering process including but not limited to: determining weight of part and the weight of waste container, mass flow sensors, vision-based sensors (e.g. cameras), etc. The sensor system may aids the de-powdering system 100 in determining whether the part or parts 106 require additional depowdering by any combination of the fluid system, the movement system of the base member 102 and the movement system of the each individual component holders 104. If it is determined through one of the sensing methods described above that there is too much excess powder located within the internal components of the part 106 then additional depowdering may occur at any one of or all of the parts 106 located at each of the individual component holders 104.

Additionally the sensor system may be utilized to determine the best orientation for the part or parts 106 to be affixed to their respective component holders 104 to most efficiently de-powder the internal components of the part or parts 106. More specifically the sensors, which may be coupled to a processor, may determine the initial orientation, and may then inform the depowdering system 100 of programmed movement of the component which further takes into consideration the internal part geometry and potential or ideal egress paths and distance for logical sub-volumes of the internal part geometry.

The de-powdering system 100 may further include an enclosure and environmental system. This environmental system may include external housing member 126, which may further comprise a rigid chamber, or more flexible system such as a bubble around the plurality of component holders 104 and the base member 102. This environmental system allows for a highly customizable inert environment to best suit each particular application for which the depowdering system may be used. For example, an inert environment below the reactivity limit of the material being processed may be utilized. Generally low oxygen for reactive metals is 2% or less, with some equipment operating even lower due to special processing conditions. Additionally the volume of the enclosure may be adjustable to fit the particular application, e.g., larger sized parts may utilize a larger volumed external housing member 126. This may be more efficient because the environment may be highly customizable for each individual application required by the external housing member 126.

The environmental system may further include a pump or exhaust mechanism 128. This exhaust mechanism may serve to seal the external housing member 126, and also to collect the excess powder and fluid during the depowdering process. Additionally the exhaust may be connected to a powder reservoir 130, which may collect the excess fluid and powder so the powder can be filtered for a later application.

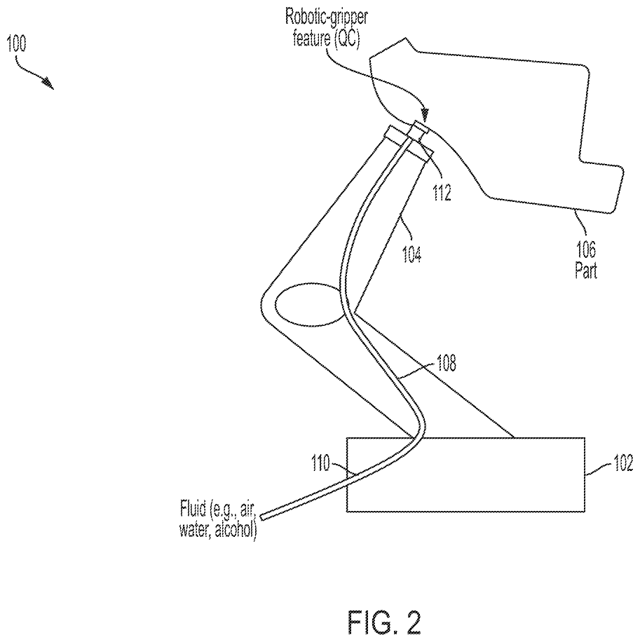

Referring to an additional example as can be seen in FIG. 2, the de-powdering system 100 may further include a base member 102 and a component holder 104, which may be in the form of a robotic arm. The base member 102 and component holder 104 of the robotic arm will similarly include a robotic-gripping feature to hold the part 106, and that may be modified to provide an internal channel 108 for a high pressure gas or fluid. The robotic arm mechanism will include the same fluid system and environmental system as described above and may additionally include the same movement of the base member.

Referring to a further additional example, each of the component holders 104 of the plurality of component holders described in reference to FIG. 1 may be interchanged with a robotic arm. This may allow for different ranges of motion for the corresponding parts 106. This additional example may be utilized for more complex parts which may required a higher degree of depowdering.

Further, each of the depowdering systems described above with respect to FIG. 1, may be applied to a standard robotic arm additive manufacturing process. This would allow for depowdering to occur in unison with the 3-D printing process for parts 106 that include complex internal structures, which may not be possible with the current depowdering practices.

1. A system for de-powdering a three-dimensionally (3D) printed structure, comprising:
a first component holder configured to removably hold the 3D printed structure at an initial orientation with respect to at least one opening to a hollow portion within the 3D printed structure;
a fluid system configured control a fluid to at least apply the fluid to the hollow portion or remove the fluid from the hollow portion to remove a powder from the hollow portion; and
a movement system configured to move at least the 3D printed structure or the fluid system according to a movement procedure based on a configuration of the hollow portion.

2. The system of claim 1, wherein the fluid system includes an internal fluid channel within a portion of the component holder, wherein the internal fluid channel is in fluid connection with a first opening to the hollow portion when the 3D printed structure is affixed to the component holder, such that the fluid flows through the portion of the component holder and the first opening to at least apply the fluid to the hollow portion or remove the fluid from the hollow portion.

3. The system of claim 1, further comprising a second component holder configured to removably hold a second 3D printed structure at a second initial orientation with respect to at least one opening to a hollow portion within the second 3D printed structure, wherein the fluid system is further configured to at least apply the fluid to the hollow portion of the second 3D printed structure or remove the fluid from the hollow portion of the second 3D printed structure, and the movement system is further configured to move at least the second 3D printed structure or the fluid system according to a movement procedure based on a configuration of the hollow portion of the second 3D printed structure.

4. The system of claim 3, wherein the wherein the fluid system includes a first internal fluid channel within a portion of the first component holder and a second internal fluid channel within a portion of the second component holder, wherein the first internal fluid channel and the second internal fluid channel are connected to one another.

5. The system of claim 1, further comprising a rigid structure connecting the component holder and the second component holder, wherein the movement system is configured to move the rigid structure such that the component holder and the second component holder are moved at the same time.

6. The system of claim 1, wherein the movement procedure of the movement system includes a vibration and a rotation configured to be applied to the 3D printed structure in a combination based on the configuration of the hollow portion.

7. The system of claim 1, further comprising:
a sensor system configured sense an amount of at least the powder or the fluid that is located within the hollow portion and adjust at least the control of the fluid by the fluid system of the movement of the movement system based on the sensed amount.

8. The system of claim 1, wherein the component holder is configured to be affixed to a 3-D printing build plate.

9. The system of claim 1, further comprising an external fluid source including a nozzle or plurality of nozzles configured to at least a apply a fluid to the hollow portion of the 3D printed structure at a second opening to the hollow portion within the 3D printed structure.

10. The system of claim 8, wherein the external fluid source is movable around the 3D printed structure to apply the fluid to the hollow portion of the 3D printed structure at a plurality of different openings to the hollow portion within the 3D printed structure.

11. The system of claim 9, wherein the plurality of nozzles may be configured to apply a fluid to the hollow portion of a plurality of different 3D printed structures located on a plurality of different component holders.

12. The system of claim 1, further comprising an external housing member configured to house and enclose at least the first component holder, the 3D printed structure, the fluid system and the movement system.

13. The system of claim 12, wherein the external housing member may further include a pump or exhaust member and a powder collection member.

14. The system of claim 12, wherein the external housing member may include a rigid chamber, or more flexible system such as a bubble, and wherein the external housing member is variable in size and volume.

15. The system of claim 12, wherein the external housing member may provide an inert environment below the reactivity limit of the utilized material of the 3D printed structure.
